(19) United States
(12) Patent Application Publication
(10) Pub. No.: US 2026/0051905 A1
(43) Pub. Date: Feb. 19, 2026

(54) DIPLEXER BANK

(71) Applicant: Scorpio Space Technologies Inc., Yoqne’am (IL)

(72) Inventor: Raviv KIRON, Yoqnea’m (IL)

(73) Assignee: Scorpio Space Technologies Inc., Yoqne’am (IL)

(21) Appl. No.: 18/804,659

(22) Filed: Aug. 14, 2024

(51) Int. Cl. H04B 1/00

(52) U.S. Cl. CPC H04B 1/0067

(57) ABSTRACT

A diplexer includes a body; a transmit port; a receive port; a common port; a T-junction part assembled in the body attached to the common port; and a plurality of pin connectors respectively attached to the transmit port, receive port and the T-junction part. The T-junction part and the plurality of pin connectors are assembled in the body by pressing without soldering.

### BACKGROUND OF THE INVENTION

### 1. Field of the Invention

The present invention relates to a diplexer and a diplexer bank, and more particularly to a diplexer and a diplexer bank used in communication systems.

### 2. Description of Background Art

A diplexer is a device used in telecommunications to combine or separate multiple signals within a specific frequency range.

The primary purpose of a diplexer is to enable the transmission and reception of different frequency bands using a single shared transmission medium or device. It accomplishes this by separating the signals based on their respective frequencies.

A typical diplexer consists of two ports, usually labeled as “Rx” (receive) and “Tx” (transmit), and one common port, the Rx and the Tx are band pass filters of any type, and the common port is matched to the two filters impedance. The Rx port is designed to receive signals within a specific frequency range, while the Tx port is used for transmitting signals within a different frequency range. The common port acts as an interface to the shared transmission medium, such as an antenna or a cable.

When used for combining signals, a diplexer takes the signals from the Rx and Tx ports and combines them into a single output on the common port. On the other hand, when used for signal separation, it takes a combined input signal from the common port and separates it into individual signals based on their frequencies, directing them to the appropriate Rx or Tx ports.

Diplexers are commonly used in various applications, including wireless communication systems, satellite communications, radar systems, and other scenarios where multiple frequency bands need to be transmitted or received simultaneously. They help simplify the overall system design by reducing the number of required components and optimizing the utilization of the available frequency spectrum.

A cavity filter is a type of RF filter that operates on the principle of resonance. Physically, it is a resonator with a “tuning screw” (to fine-tune the frequency) inside a “conducting box”. An RF or microwave resonator is a closed metallic structure (i.e., waveguides with both ends terminated in a short circuit). The resonator oscillates with higher amplitude at a specific set of frequencies, called resonant frequencies. When an RF signal passes through the cavity filter, a resonator acts as a band-pass filter and passes RF signals at particular frequencies (i.e., resonant frequencies) while blocking other nearby frequencies.

The resonant frequency of the cavity resonator depends on its dimension (length, width, height), mode number, dielectric constant (εr), and magnetic permeability (μr) of the material of construction. In a cavity filter, the resonator is fitted with a screw to tune the frequency range which allows to modify the physical length (inner space length) of the resonator as well as its capacitance to the ground, hence tuning the resonant frequency.

### SUMMARY OF THE INVENTION

Usually, a common aperture antenna for receiving and transmitting utilizes a diplexer in order to obtain an adequate isolation between the transmitter and the receiver. In a phase array antenna where the aperture is composed of N×N elements, the common practice is to separate the transmit aperture from the receive aperture which is a redundant usage of a Diplexer. However, this doubles the size of the antenna, because there are two apertures covering an existing surface.

Accordingly, it is an object of the present invention to provide a diplexer and a diplexer bank which achieve improved signal isolation and reduced size while maintaining high efficiency and low insertion loss.

To achieve the above-mentioned object, according to a first aspect of the present invention a diplexer is provided, which includes a body; a transmit port; a receive port; a common port; a T-junction part assembled in the body attached to the common port; and a plurality of pin connectors respectively attached to the transmit port, receive port and the T-junction part. The T-junction part and the plurality of pin connectors are assembled in the body by pressing without soldering.

According to a second aspect of the present invention, a diplexer bank is provided, which comprises multiple diplexers, wherein the multiple diplexers are connected together, and are geometrically aligned and stacked directly on top of one another.

The present invention offers significant advantages in its small size with high performances by a simple manufacturing and assembly process, and by the simple modularity which enables adding multiple units side by side.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to one of ordinary skill in the art from this detailed description.

### BRIEF DESCRIPTION OF THE DRAWINGS

The present invention will become more fully understood from the detailed description given below and the accompanying drawings that are given by way of illustration only and are thus not limitative of the present invention.

FIG. 1 is a plan view of a diplexer according to one embodiment of the invention;

FIG. 2 is a cross-sectional view of the diplexer in FIG. 1 according to one embodiment of the present invention;

FIG. 2A is a partial view of the diplexer in FIG. 1 according to one embodiment of the present invention;

FIG. 2B is a plan view of a port connector in connection with the diplexer in FIG. 1 according to one embodiment of the present invention;

FIG. 3A is a plan view of a T-junction part according to one embodiment of the present invention;

FIG. 3B is another view of the T-junction part in FIG. 3A according to one embodiment of the present invention;

FIG. 3C is a partial view of the diplexer in FIG. 1 without a T-junction part installed according to one embodiment of the present invention;

FIG. 3D is a partial view of the diplexer in FIG. 1 with a T-junction part installed according to one embodiment of the present invention;

FIG. 4 is a diagram to show the diplexer Rx/Tx insertion loss according to one embodiment of the present invention;

FIG. 5 is a diagram to show the diplexer Rx/Tx frequency response according to one embodiment of the present invention; and

FIG. 6 is a plan view of a diplexer bank according to one embodiment of the present invention.

### DETAILED DESCRIPTION OF THE INVENTION

The present invention will now be described in detail with reference to the accompanying drawings, wherein the same reference numerals will be used to identify the same or similar elements throughout the several views. It should be noted that the drawings should be viewed in the direction of orientation of the reference numerals.

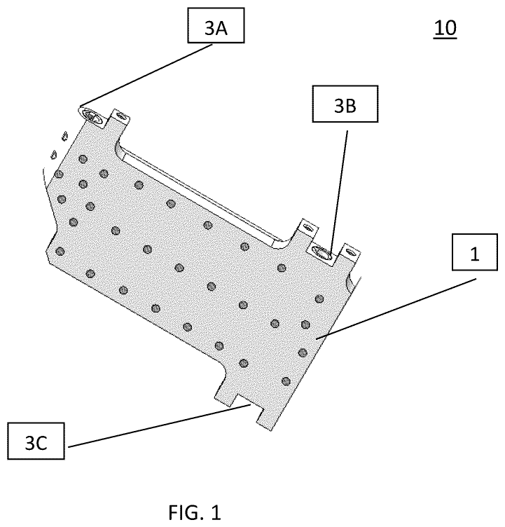

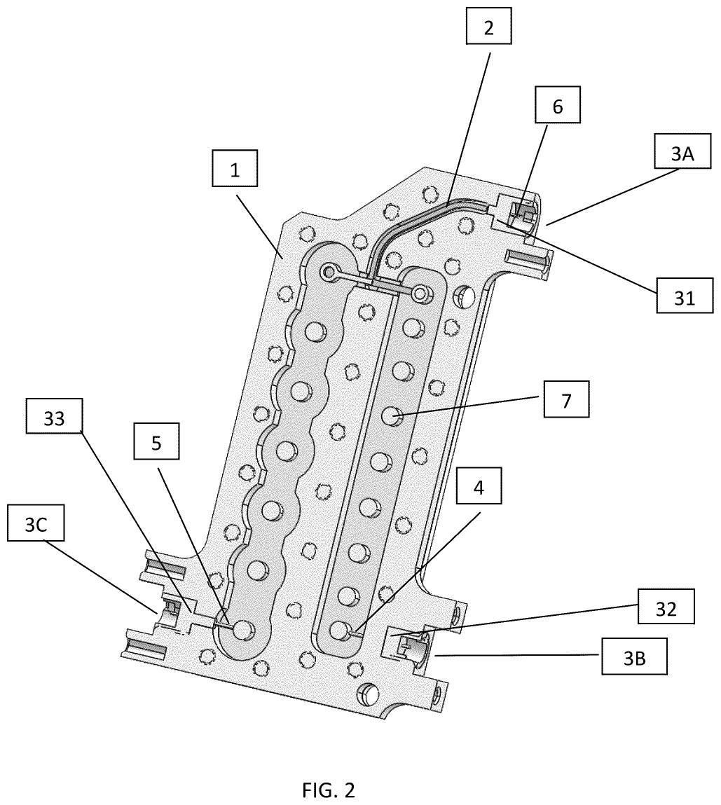

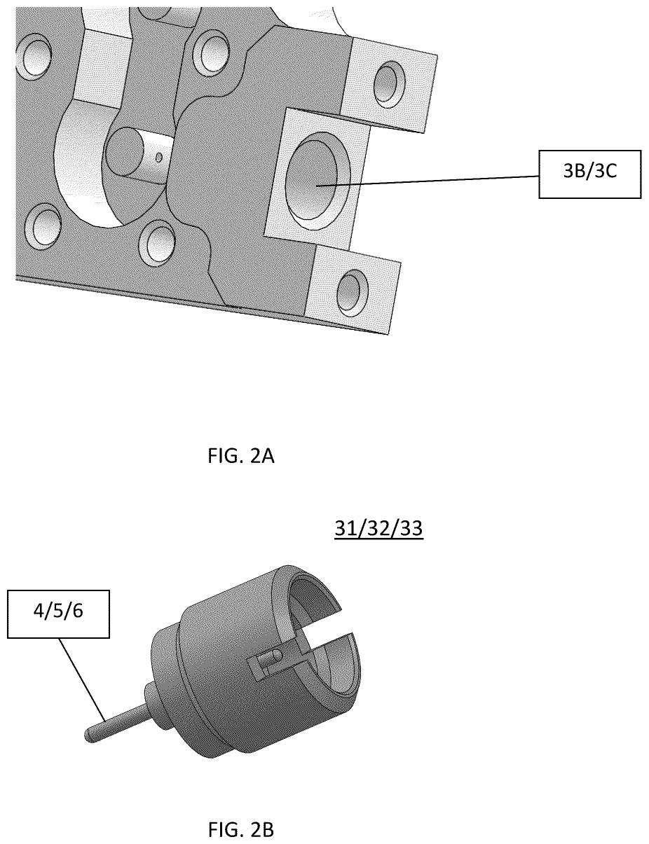

FIGS. 1 and 2 show a single diplexer according to one embodiment of the invention. A diplexer typically consists of two bandpass filters connected to a common port. The structure can vary based on the operating frequency, filter technology, and other electrical and mechanical constraints. A diplexer is typically made of a dielectric material, such as alumina, glass, or plastic. This material has a low electrical conductivity, which helps to reduce signal losses. The diplexer may also contain metal components, such as a metal housing or a metal ground plane. These components help to shield the diplexer from electromagnetic interference and provide a stable electrical ground. The diplexer may also include capacitors for storing electrical energy, which can be made of a variety of materials, including ceramic, film, or mica, and inductors for storing magnetic energy, which can be made of a variety of materials, including copper, aluminum, or iron.

As depicted in FIG. 2, the diplexer 10 has a diplexer body 1 made of metal, including an Rx (receive) port 3B designed to handle incoming signals from the antenna, passing a specific frequency band to the receiver, a Tx (transmit) port 3C designed to handle outgoing signals from the transmitter and allowing a specific frequency band to pass through to the antenna, and a common port 3A shared by both the Rx and Tx paths. Each port has a port connector installed therein. The diplexer body 1 further includes a plurality of resonators 7 that are used to filter signals. According to one embodiment of the present invention, the resonators 7 are part of the diplexer body and are made of the same metallic material as the diplexer body 1.

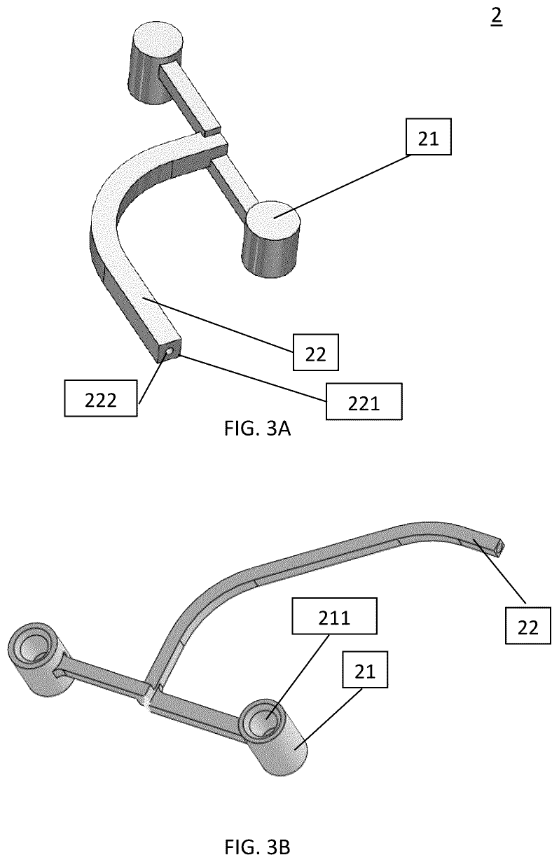

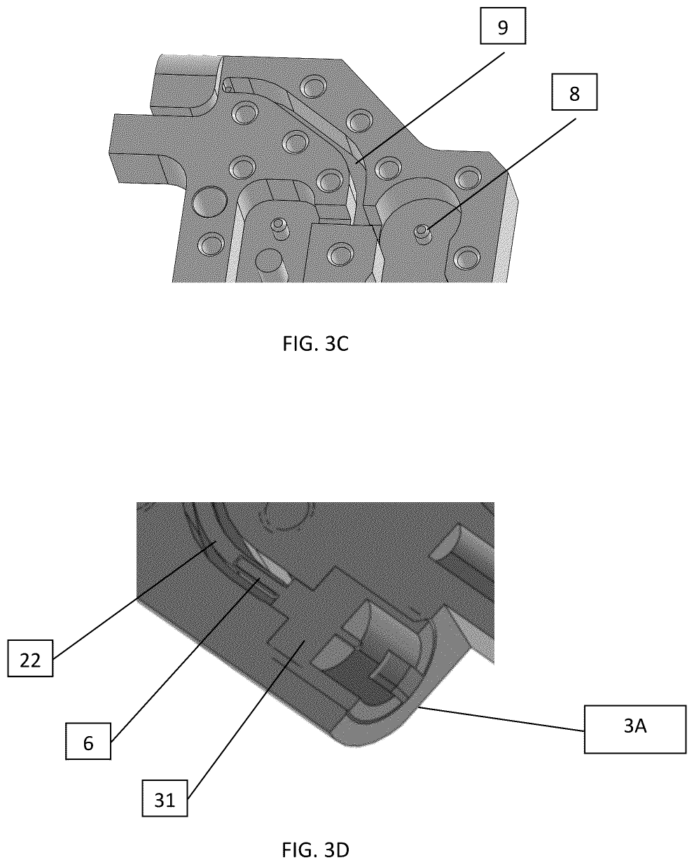

FIG. 2A shows a close-up view of the port 3B/3C with a cylindrical portion for receiving a port connector. As shown in FIG. 2, the port connectors 31, 32 and 33 are respectively installed in the common port 3A, Rx port 3B and Tx port 3C. FIG. 2B shows a port connector in connection with the diplexer, including a cylindrical portion corresponding to the respective port and a connector pin. The present invention utilizes the small dimensions of a cavity filter, and the port matching is based on a T-junction structure, which contacts the Rx filter and Tx filter by a pressing technique without any usage of soldering. According to one embodiment of the present invention, the common port 3A is used with a T-junction part 2, which simplifies the manufacturing process while keeping high performance, by adding the T-junction part (shown in FIGS. 3A and 3B) by a simple press, together with three connector pins 4, 5, 6 of the three port connectors 31/32/33 respectively in port 3A—common port, port 3B—receiving port, and port 3C—transmitting port.

More specifically, FIGS. 3A and 3B show the T-junction part 2 used in the diplexer body 1 in FIGS. 1 and 2. As depicted in FIGS. 3A and 3B, the T-junction part 2 has three ends including two first ends 21 and one second end 22. Each first end 21 of the T-junction part 2 is formed with a cavity 211 on the bottom surface, and is configured to be pressed and sleeve on a respective pin 8 formed in the diplexer body 1 as shown in FIG. 3C without the necessity of soldering or with a simple soldering process. As depicted in FIGS. 3C and 3D, the diplexer body 1 is provided with a groove 9 for receiving the second end 22 of the T-junction part 2. The T-junction part 2 is assembled to the diplexer body 1 by pressing the T-junction part 2 to the diplexer body 1 such that the two first ends 21 sleeve on the corresponding pins 8, and the second end 22 fits into the groove 9, without the necessity of soldering or with a simple soldering process. As shown in FIG. 3A, the end surface 221 of the second end 22 of the T-junction part 2 includes a hole 222. Assembling the T-junction part 2 to the diplexer body 1 further includes attaching the connector pin 6 of the port connector 31 into the hole 222 of the T-junction part 2, as shown in FIG. 3D. By pressing the T-junction part 2 to the diplexer body 1 without the necessity of soldering or with a simple soldering process, it completes and ends the resonators array with the same size of resonators—the two ends 21 of the T-junction part 2 after assembling function as all other resonators 7 and create the common port which go to the port connector 31, by a long thin wire-like structure. In addition, one end of each of the connector pins 4, 5 is connected to the respective resonator 7 with a designated drill, and the other end is connected to the corresponding port connector 32, 33 which is in turn assembled to the corresponding cylindrical port 3B/3C as shown in FIG. 2, without the necessity of soldering or with a simple soldering process.

According to one embodiment of the present invention, the specific diplexer is set to Ku band from 10 GHz to 15 GHz, with characteristic as described, with dimensions of 9 mm in width, 21 mm in height and 50 mm in length, with very low loss, and high isolation between Tx and Rx. The dimensions are a constraint to a certain frequency band. The ones that are mentioned above are designed to the specific Ku band, but the implementation can be applied to any band with different dimensions.

Every Diplexer Has 3 Major Factors:
Isolation—determines what is the isolation level from the Tx to Rx and from Rx to Tx, desired as high as possible;
Insertion Loss—determines how much loss Does the Tx and the Rx have, desired as low as possible;
Return Loss—determines how good is the matching of the ports, desire as high as possible its absolute value.

All those parameters are determined by the higher level design, and are a tradeoff between themselves and the dimensions. The small cavity diplexer according to the present invention has achieved all of the above regardless of its small size.

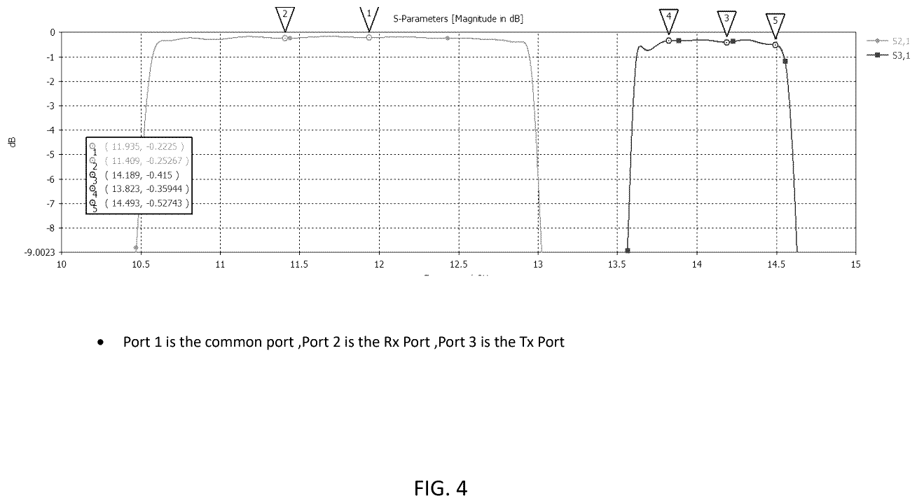

FIG. 4 shows a simulation of the diplexer Insertion loss in the passband, common to port 1 0.15 dB to 0.25 dB at frequencies: 10.7 GHz to 12.75 GHz, and common to port 2 0.25 dB to 0.35 dB at frequencies: 13.75 to 14.5 GHz. Other frequencies are irrelevant.

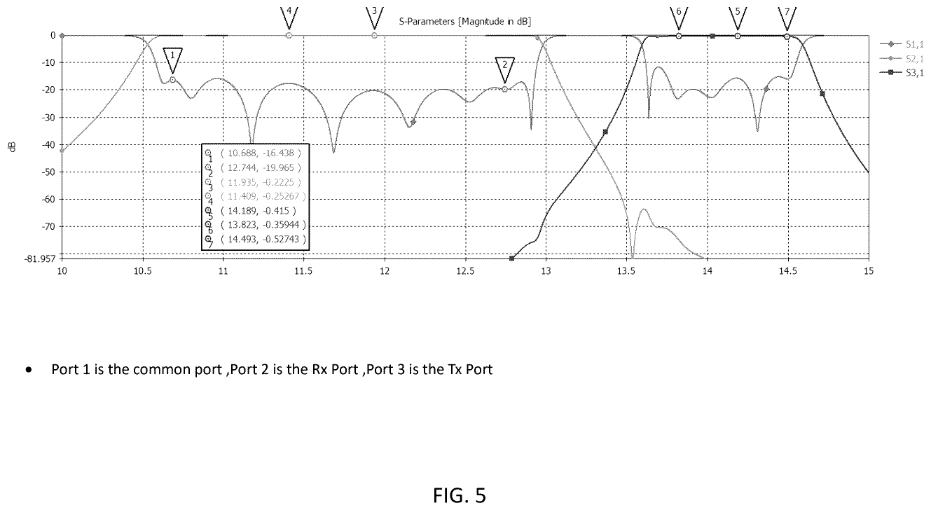

FIG. 5 shows the isolation and the return loss of each passband:
Common to port 1 isolation of frequencies lower than 12.75 GHz is below 80 dB (exceeded the axis range),
Common to port 2 isolation of frequencies higher than 13.75 GHz is less than 75 dB,
The return loss (ripple curves) at frequencies of 10.7 GHz to 12.75 and 13.75 to 14.5 GHz is better than 20 dB.

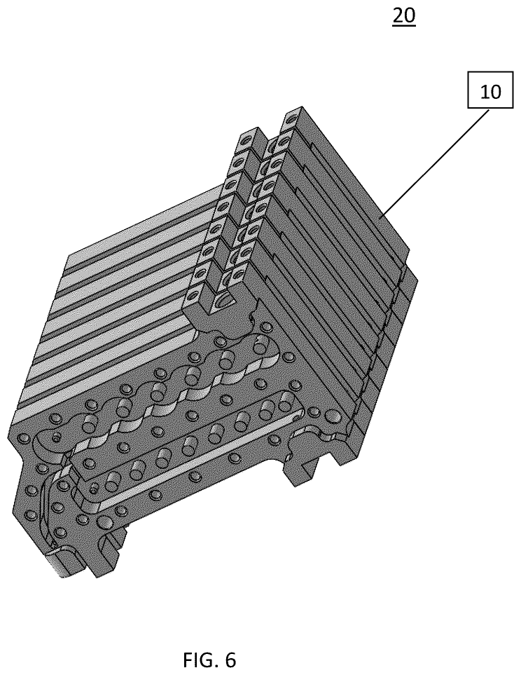

FIG. 6 shows a plan view of a diplexer bank 20 according to one embodiment of the present invention. An antenna array with N×N elements, with row summing architecture, has N ports. A diplexer bank can enable efficient use of the antenna aperture for both transmission and reception. It consists of multiple diplexer modules, each designed to interface with a dedicated antenna element. This configuration allows for simultaneous transmission and reception on multiple channels, optimizing antenna performance and reducing interference between elements. By closely matching the antenna element spacing to the operating wavelength, the diplexer bank achieves a higher degree of spatial selectivity, leading to an improved signal-to-noise ratio and increased data throughput.

One embodiment of the present invention is to utilize the same aperture to transmit and receive, and design a diplexer bank which consists of N replicas of a diplexer that must interface with N antenna ports which are evenly spread along the antenna with a dimension close to λ/2, which is in a specific implementation 9 mm.

The common implementation in antennas is to use one, or maybe 2 diplexers per system. In the present invention, due to the geometric structure, a diplexer bank can be created by replicating many of the single diplexers according to the embodiment of present invention, which is able to separate multiple Tx and Rx channels according to the antenna dimensions. In particular, this diplexer bank efficiently separates incoming signals into multiple receive (Rx) channels based on their frequency bands, enabling simultaneous reception of multiple data streams. Conversely, it effectively combines multiple transmit (Tx) signals from different sources into a composite signal for transmission, optimizing antenna utilization and system throughput. This modular design of the diplexer bank allows for scalability, accommodating a wide range of antenna array sizes and system capacities. This flexibility enhances system performance and adaptability to evolving communication standards and requirements.

As depicted in FIG. 6, the diplexer bank 20 is a replica of 8 single diplexers each of which may have the same structure as depicted in the diplexer 10 of FIG. 1. The 8 single diplexers are geometrically aligned and directly stacked on one another. It is to be understood that the diplexer bank can include a variable number of diplexers as needed, and the number of diplexer modules within the bank can be scaled to accommodate various antenna array configurations and system requirements.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A diplexer, comprising:
a body including a transmit port, a receive port, and a common port;
a T-junction part assembled in the body and attached to the common port; and
a plurality of port connectors respectively attached to the transmit port, receive port and the T-junction part,
wherein the T-junction part is assembled in the body and connected to a corresponding port connector by pressing without soldering.

2. The diplexer according to claim 1, wherein each of the plurality of port connectors include a main portion attached to the corresponding port and a connector pin.

3. The diplexer according to claim 2, wherein the T-junction part includes three ends, with two first ends configured to be pressed to sleeve on pins on the body, and one second end attached to the common port.

4. The diplexer according to claim 3, wherein each of the two first ends of the T-junction part is provided with a cavity on a bottom surface, said cavity being configured to receive the connector pin formed in the body.

5. The diplexer according to claim 3, wherein the second end of the T-junction part is provided with a hole on an end surface, said hole being configured to receive the connector pin of a corresponding port connector attached to the common port.

6. The diplexer according to claim 1, wherein the body includes a plurality of tubular resonators, and two of the plurality of tubular resonators are formed by assembling of the T-junction part to the body.

7. A diplexer bank, comprising multiple of the diplexer according to claim 1,
wherein the multiple diplexers are connected together, and are geometrically aligned and stacked directly on top of one another.

8. The diplexer bank according to claim 7, wherein a number of the multiple diplexers is more than two.
